(19) United States
(12) Patent Application Publication
(10) Pub. No.: US 2009/0131239 A1
(43) Pub. Date: May 21, 2009

(54) BASE GLASS COMPOSITION FOR GRADED-REFRACTIVE-INDEX ROD LENS AND GRADED-REFRACTIVE-INDEX ROD LENS PRODUCED FROM THE SAME

(76) Inventors: Tsuyoshi Kotake, Tokyo (JP); Koichi Sakaguchi, Tokyo (JP); Teruhide Inoue, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/281,157

(22) PCT Filed: Mar. 2, 2007
(86) PCT No.: PCT/JP2007/054077

§ 371 Date: Aug. 29, 2008

(30) Foreign Application Priority Data
Mar. 3, 2006 (JP) 2006-057339

(51) Int. Cl. C03C 3/097; C03C 3/089; C03C 3/066; C03C 3/064; G02B 1/00; G02B 3/10

(52) U.S. Cl. 501/63; 501/65; 501/79; 501/77; 359/652

(57) ABSTRACT

A glass composition suitable for producing a graded-refractive-index rod lens having an angular aperture of 16-20° without containing lead or thallium and a graded-refractive-index rod lens produced from the composition are provided.

The composition is a base glass composition for graded-refractive-index rod lenses, characterized by comprising, in terms of % by mole, 20≦SiO₂≦52, 1≦B₂O₃≦30, 12≦Li₂O≦18, 8≦Na₂O≦15, 0≦MgO≦15, 0≦SrO≦10, 0≦BaO≦10, 0≦ZnO≦15, 0≦TiO₂≦15, 0≦Nb₂O₅≦5, 0≦Ta₂O₅≦5, and 3<Bi₂O₃≦13, provided that 45≦SiO₂+B₂O₃≦65, 9≦MgO+ZnO+TiO₂≦25, and 0≦Nb₂O₅+Ta₂O₅≦5, and by containing substantially no lead and substantially no thallium.

### TECHNICAL FIELD

The present invention relates to a glass composition suitable for producing a light-transmitting material, in particular, for producing a rod lens having a refractive-index distribution in which the refractive index decreases from the axis toward the surface continuously, preferably parabolically (hereinafter referred to as graded-refractive-index rod lens). The invention further relates to a graded-refractive-index rod lens produced from the composition.

### BACKGROUND ART

A graded-refractive-index rod lens is a rod-form lens which has such a refractive-index distribution that the refractive index decreases parabolically from the center toward the periphery in the section. This lens has the property of focusing or collimating light rays and is hence used as an optical part.

This graded-refractive-index rod lens further has the property of forming an erecting one-magnification image. Because of this, optical elements including such rod lenses disposed in a one-dimensional or two-dimensional arrangement are recently used as optical systems in copiers, facsimile telegraphs, LED array printers, scanners, etc.

Graded-refractive-index rod lenses, which have such applications, are being produced, for example, by the ion-exchange method. The ion-exchange method is a method in which a base glass containing cations of a first element (e.g., Li⁺) capable of constituting a modifying oxide is brought into contact with a molten salt containing cations of a second element (e.g., Na⁺) capable of constituting a modifying oxide to thereby replace cations of the first element with cations of the second element present in the molten salt.

In order for a graded-refractive-index rod lens to be used as an optical element such as those shown above, the lens is required to have a large angular aperture. A base glass composition for graded-refractive-index rod lenses which contains thallium so as to meet the requirement is known (e.g., JP-A-2004-292215). There is a statement therein to the effect that a graded-refractive-index rod lens produced from this base glass composition has an angular aperture of 10.8-25.4°.

### DISCLOSURE OF THE INVENTION

### Problem that the Invention is to Solve

However, thallium is a substance which imposes a heavy burden on the environment although the burden is lighter than that of lead. From the standpoint of environmental preservation, thallium is a substance whose use is desired to be avoided like that of lead.

The invention has been achieved in view of such a problem of conventional techniques. An object of the invention is to provide a base glass composition which contains neither lead nor thallium and is suitable for producing a graded-refractive-index rod lens having an angular aperture of 16-20°. Another object of the invention is to provide a graded-refractive-index rod lens produced from the composition.

### Means for Solving the Problem

In order to overcome the problem, the invention provides, according to one aspect thereof, a base glass composition for graded-refractive-index rod lenses, characterized by comprising, in terms of % by mole,

20≦SiO₂≦52,

1≦B₂O₃≦30,

12≦Li₂O≦18,

8≦Na₂O≦15,

0≦MgO≦15,

0≦SrO≦10,

0≦BaO≦10,

0≦ZnO≦15,

0<TiO₂≦15,

0≦Nb₂O₅≦5,

0≦Ta₂O₅≦5, and

3≦Bi₂O₃≦13,

provided that

45≦SiO₂+B₂O₃≦65,

9≦MgO+ZnO+TiO₂≦25, and

0≦Nb₂O₅+Ta₂O₅≦5,

and by containing substantially no lead and substantially no thallium.

The glass composition according to the invention (hereinafter often referred to as “glass composition of the invention”) is explained below in detail.

### (SiO₂)

The glass composition of the invention contains SiO₂ in an amount in the range of 20%-52% by mole. SiO₂ is a main component of the framework structure of the glass. In case where the content thereof is lower than 20%, vitrification is difficult. In case where the content thereof exceeds 52%, the content of ingredients for obtaining a necessary angular aperture is limited. A preferred range for obtaining the angular aperture is up to 45%.

### (B₂O₃)

The Glass Composition of the Invention Contains B₂O₃ in an amount in the range of 1%-30% by mole. B₂O₃ is a main component of the framework structure of the glass. Furthermore, B₂O₃ has the effect of enlarging angular aperture and the effect of inhibiting the glass from assuming a color caused by the existence of B₂O₃. In case where the content thereof is lower than 1%, these effects are insufficient. A preferred range is 6% or higher. The higher the content of B₂O₃, the higher the effects. However, contents thereof exceeding 30% by mole result in a glass having impaired unsusceptibility to devitrification and impaired resistance to molten salts.

### (SiO₂+B₂O₃)

The glass composition of the invention contains SiO₂ and B₂O₃ in a total amount in the range of 45%-65% by mole. In case where the total content of SiO₂ and B₂O₃ is lower than 45%, vitrification is difficult. In case where the total content thereof exceeds 65%, the content of ingredients for obtaining a necessary angular aperture is limited. The total content thereof is preferably in the range of 50%-60%.

### (Li₂O)

The glass composition of the invention contains Li₂O in an amount in the range of 12%-18% by mole. Li₂O is an essential component for forming a refractive-index distribution. In case where the content of Li₂O is lower than 12%, it is difficult to produce a graded-refractive-index rod lens having a desired angular aperture. Although increasing the content thereof can increase the angular aperture, contents thereof exceeding 18% result in a glass having impaired unsusceptibility to devitrification.

### (Na₂O)

The glass composition of the invention contains Na₂O in an amount in the range of 8%-15% by mole. Na₂O is an essential component for regulating refractive-index distribution to produce a graded-refractive-index rod lens having a satisfactory refractive-index distribution. As stated above, the range of Li₂O content in the invention was first regulated to 12%-18% in order to form a refractive-index distribution. With respect to the content of Na₂O, which also is an alkali metal oxide, it must be regulated so as to be in the range of 8%-15% in order to obtain a satisfactory refractive-index distribution.

### (MgO)

The glass composition of the invention contains MgO in an amount in the range of 0%-15% by mole. MgO has the effect of enlarging angular aperture. The higher the content thereof, the higher the effect. It is preferred that MgO be contained in an amount of 2% or higher. However, contents thereof exceeding 15% result in a glass having impaired unsusceptibility to devitrification. The content thereof is hence 15% or lower, more preferably 10% or lower.

### (SrO)

The glass composition of the invention may contain SrO in an amount in the range of 0%-10% by mole. Although SrO is not an essential component, it is an ingredient effective in lowering melting temperature and increasing refractive index.

### (BaO)

The glass composition of the invention may contain BaO in an amount in the range of 0%-10% by mole. Although BaO is not an essential component, it is an ingredient effective in lowering melting temperature and increasing refractive index.

### (ZnO)

The glass composition of the invention contains ZnO in an amount in the range of 0%-15% by mole. ZnO has the effect of enlarging angular aperture. The higher the content thereof, the higher the effect. However, contents thereof exceeding 15% result in a glass having impaired unsusceptibility to devitrification. The content thereof is hence 15% or lower, more preferably 10% or lower.

### (TiO₂)

The glass composition of the invention contains TiO₂ in an amount in the range of 0%-15% by mole, excluding 0% by mole. TiO₂ is an essential component having the effect of making the shape of the refractive-index distribution satisfactory. When TiO₂ is not contained, a sufficient effect is not obtained. TiO₂ further has the effect of enlarging angular aperture. The higher the content thereof, the higher the effects. However, contents thereof exceeding 15% result in a glass having impaired unsusceptibility to devitrification. The content thereof is hence 15% or lower. The content of TiO₂ is more preferably in the range of 2%-10%.

### (MgO+ZnO+TiO₂)

In the glass composition of the invention, the total content of MgO, ZnO, and TiO₂ is in the range of 9%-25% by mole from the standpoint of obtaining a desired angular aperture. In case where the total content thereof is lower than 9%, it is difficult to obtain the desired angular aperture. The higher the total content thereof, the more the angular aperture can be enlarged. However, total contents thereof exceeding 25% result in a glass having impaired unsusceptibility to devitrification.

### (Nb₂O₅)

The glass composition of the invention contains Nb₂O₅ in an amount in the range of 0%-5% by mole. Nb₂O₅ has the effect of increasing refractive index. The higher the content thereof, the higher the effect. However, contents thereof exceeding 5% result in a glass having impaired unsusceptibility to devitrification.

### (Ta₂O₅)

The glass composition of the invention contains Ta₂O₅ in an amount in the range of 0%-5% by mole. Ta₂O₅ has the effect of increasing refractive index. The higher the content thereof, the higher the effect. However, contents thereof exceeding 5% result in a glass having impaired unsusceptibility to devitrification.

### (Nb₂O₅+Ta₂O₅)

In the glass composition of the invention, the total content of Nb₂O₅ and Ta₂O₅ is in the range of 0%-5% by mole from the standpoint of obtaining a desired angular aperture. The higher the total content thereof, the more the refractive index can be increased. However, total contents thereof exceeding 5% result in a glass having impaired unsusceptibility to devitrification. The total content thereof is hence 5% or lower, more preferably 3% or lower.

### (Bi₂O₃)

The glass composition of the invention contains Bi₂O₃ in an amount in the range of 1%-13% by mole. A preferred range of the content thereof is 3%-7%.

Bi₂O₃ has the effect of increasing refractive index and angular aperture. Bi₂O₃ further has the effect of lowering the melting temperature of the glass. However, in case where the content thereof is lower than 1%, it is difficult to obtain these effects. For obtaining sufficient effects, it is desirable to regulate the content thereof so as to exceed 3%. On the other hand, the higher the content thereof, the higher the effects. However, contents thereof exceeding 7% result in a glass which has a color or has impaired unsusceptibility to devitrification. Higher Bi₂O₃ contents result in absorption in the range of visible-light wavelengths, and this results in the necessity of suitably selecting a wavelength to be used. In case where the content thereof exceeds 13%, coloration becomes severe and unsusceptibility to devitrification becomes worse.

The glass composition of the invention contains substantially no lead and substantially no thallium. The term “contains substantially no lead or thallium” means that unavoidable inclusion from an industrial raw material is permitted. Namely, when a glass is in the state which is the generally called lead-free state regarding lead containment, this means that the glass contains substantially no lead (the same applies also to thallium).

In the general preparation of raw glass materials and general melting operations, there are usually no cases where lead oxide or thallium oxide comes as an unintended unavoidable impurity into the glass in such a degree that it is detectable with an analyzer such as, e.g., an X-ray microanalyzer (XMA).

On the other hand, with respect to the definition of “lead-free”, the content of lead in terms of lead metal is required to be “0.1% by weight or lower based on the homogeneous material” according to an expression in, e.g., the European Restriction of Hazardous Substances (ROHS Order). When that content is converted to molar value in the glass system of the invention, it is about 0.025% by mole or lower in terms of lead oxide amount. This means that so long as the glass system of the invention has a lead oxide content of about 0.025% by mole or lower, it is lead-free. The same applies in the case of thallium oxide.

The invention further provides, according to another aspect thereof, a graded-refractive-index rod lens obtained by forming the base glass composition for graded-refractive-index rod lenses described above into a cylindrical rod and treating the rod by the ion-exchange method to form a refractive-index distribution therein.

This graded-refractive-index rod lens can have an angular aperture of 16-20°.

### ADVANTAGES OF THE INVENTION

As explained above, a glass composition suitable for the production of a graded-refractive-index rod lens having an angular aperture of 16-20° can be obtained according to the invention without using lead or thallium. Furthermore, a graded-refractive-index rod lens produced from the composition can be obtained. In addition, graded-refractive-index rod lenses according to the invention can be used to produce an optical element such as, e.g., a rod lens array.

### BRIEF DESCRIPTION OF THE DRAWINGS

FIGS. 1A and 1B are diagrammatic views illustrating a graded-refractive-index rod lens according to the invention.

FIG. 2 is a graph showing a transmission spectrum of a glass having the makeup of Example 17.

### DESCRIPTION OF THE REFERENCE NUMERAL AND SIGN

1: graded-refractive-index rod lens
nᵣ: refractive-index distribution curve

### BEST MODE FOR CARRYING OUT THE INVENTION

The invention will be explained below in detail by reference to Examples and Comparative Examples.

First, in producing base glass compositions in the Examples, use was made of silicon oxide, boric acid, lithium carbonate, sodium carbonate, magnesium carbonate, zinc oxide, titanium oxide, niobium oxide, tantalum oxide, and bismuth oxide as raw materials for the components shown in Table 1.

In producing base glass compositions in the Comparative Examples, use was made of lanthanum oxide and barium carbonate, besides the raw materials used in the Examples, as raw materials for the components shown in Table 2.

### EXAMPLES 1 TO 19

Raw materials were mixed according to each of the makeups of Examples 1 to 19 shown in Tables 1 to 3, and the mixture was melted to produce a base glass composition. The melting was conducted at 1,000-1,200° C. This base glass, which had not undergone an ion-exchange treatment, was examined for refractive index and glass transition point. A measurement of refractive index was made with a Pulfrich refractometer at a measuring wavelength of 656.3 nm by the total-reflection critical method. Glass transition point was read in a thermal-expansion curve by determining the temperature corresponding to a bending point appearing in the curve.

TABLE 1

| | | Example No. | | | | | |
|---|---|---|---|---|---|---|---|
| | | 1 | 2 | 3 | 4 | 5 | 6 |
| Component | SiO₂ | 40.0 | 30.0 | 22.0 | 34.0 | 32.0 | 40.0 |
| [mol %] | B₂O₃ | 10.0 | 20.0 | 30.0 | 20.0 | 20.0 | 18.0 |
| | Li₂O | 14.0 | 16.0 | 13.5 | 13.0 | 13.0 | 13.5 |
| | Na₂O | 10.0 | 10.0 | 10.0 | 9.0 | 11.0 | 10.0 |
| | MgO | 7.0 | 10.0 | 7.0 | 6.0 | 6.0 | 4.0 |
| | ZnO | 8.0 | 0.0 | 6.0 | 7.0 | 7.0 | 4.0 |
| | TiO₂ | 7.0 | 10.0 | 7.0 | 6.0 | 6.0 | 4.0 |
| | Nb₂O₅ | 0.0 | 0.0 | 0.0 | 0.0 | 0.0 | 0.0 |
| | Ta₂O₅ | 0.0 | 0.0 | 0.0 | 0.0 | 0.0 | 0.0 |
| | La₂O₃ | 0.0 | 0.0 | 0.0 | 0.0 | 0.0 | 0.0 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | Bi₂O₃ | 4.0 | 4.0 | 4.0 | 5.0 | 5.0 | 6.0 |
| | SiO₂ + B₂O₃ | 50.0 | 50.0 | 52.0 | 54.0 | 52.0 | 58.0 |
| | MgO + ZnO + TiO₂ | 22.0 | 20.0 | 20.0 | 19.0 | 19.0 | 12.0 |
| | Nb₂O₅ + Ta₂O₅ | 0.0 | 0.0 | 0.0 | 0.0 | 0.0 | 0.0 |
| Glass | Glass | 444 | 449 | 448 | 453 | 440 | 444 |
| prop- | transition | | | | | | |
| erty | point [° C.] | | | | | | |
| | Refractive | 1.688 | 1.697 | 1.680 | 1.691 | 1.683 | 1.676 |
| | index | | | | | | |
| Lens | Angular | 17.7 | 19.3 | 18.6 | 17.0 | 16.2 | 16.3 |
| prop- | aperture θ [°] | | | | | | |
| erty | Δfₘₐₓ[μm] | 150 | 150 | 100 | 200 | 50 | 150 |

TABLE 2

| | | Example No. | | | | | | | |
|---|---|---|---|---|---|---|---|---|---|
| | | 7 | 8 | 9 | 10 | 11 | 12 | 13 | 14 |
| Compo- | SiO₂ | 50.5 | 50.5 | 46.5 | 43.5 | 46.5 | 48.0 | 44.5 | 46.5 |
| nent | B₂O₃ | 6.0 | 6.0 | 5.0 | 5.0 | 2.0 | 6.0 | 4.0 | 6.0 |
| [mol %] | Li₂O | 14.5 | 15.5 | 13.5 | 13.5 | 13.5 | 15.0 | 13.5 | 13.5 |
| | Na₂O | 10.0 | 9.0 | 12.0 | 12.0 | 12.0 | 10.0 | 13.0 | 11.0 |
| | MgO | 6.0 | 6.0 | 8.0 | 8.0 | 8.0 | 6.0 | 10.0 | 10.0 |
| | ZnO | 0.0 | 0.0 | 0.0 | 0.0 | 0.0 | 0.0 | 0.0 | 0.0 |
| | TiO₂ | 6.0 | 6.0 | 6.0 | 9.0 | 9.0 | 6.0 | 6.0 | 6.0 |
| | Nb₂O₅ | 0.0 | 0.0 | 0.0 | 0.0 | 0.0 | 0.0 | 0.0 | 0.0 |
| | Ta₂O₅ | 0.0 | 0.0 | 0.0 | 0.0 | 0.0 | 0.0 | 0.0 | 0.0 |
| | La₂O₃ | 0.0 | 0.0 | 0.0 | 0.0 | 0.0 | 0.0 | 0.0 | 0.0 |
| | SrO | 0.0 | 0.0 | 0.0 | 0.0 | 0.0 | 0.0 | 0.0 | 0.0 |
| | BaO | 0.0 | 0.0 | 0.0 | 0.0 | 0.0 | 0.0 | 0.0 | 0.0 |
| | Bi₂O₃ | 7.0 | 7.0 | 9.0 | 9.0 | 9.0 | 9.0 | 9.0 | 7.0 |
| | SiO₂ + B₂O₃ | 56.5 | 56.5 | 51.5 | 48.5 | 48.5 | 54.0 | 48.5 | 52.5 |
| | MgO + ZnO + TiO₂ | 12.0 | 12.0 | 14.0 | 17.0 | 17.0 | 12.0 | 16.0 | 16.0 |
| | Nb₂O₅ + Ta₂O₅ | 0.0 | 0.0 | 0.0 | 0.0 | 0.0 | 0.0 | 0.0 | 0.0 |
| Glass | Glass | 439 | 441 | 420 | 422 | 427 | 427 | 411 | 433 |
| prop- | transition | | | | | | | | |
| erty | point [° C.] | | | | | | | | |
| | Refractive | 1.700 | 1.702 | 1.735 | 1.760 | 1.760 | 1.734 | 1.740 | 1.707 |
| | index | | | | | | | | |
| Lens | Angular | 16.4 | 17.9 | 17.0 | 18.4 | 18.4 | 17.6 | 16.7 | 17.3 |
| prop- | aperture θ | | | | | | | | |
| erty | [°] | | | | | | | | |
| | Δfₘₐₓ[μm] | 100 | 140 | 10 | 40 | 40 | 110 | 60 | 10 |

TABLE 3

| | | Example No. | | | | | | | |
|---|---|---|---|---|---|---|---|---|---|
| | | 15 | 16 | 17 | 18 | 19 | 20 | 21 | 22 |
| Compo- | SiO₂ | 47.5 | 44.5 | 48.5 | 47.5 | 45.5 | 48.0 | 35.0 | 44.0 |
| nent | B₂O₃ | 6.0 | 6.0 | 5.0 | 5.0 | 5.0 | 5.0 | 20.0 | 6.0 |
| [mol %] | Li₂O | 13.5 | 13.5 | 13.5 | 13.5 | 13.5 | 13.0 | 14.0 | 14.0 |
| | Na₂O | 11.0 | 11.0 | 12.0 | 12.0 | 12.0 | 9.0 | 11.0 | 11.0 |
| | MgO | 6.0 | 10.0 | 6.0 | 6.0 | 6.0 | 7.0 | 5.0 | 8.0 |
| | ZnO | 3.0 | 0.0 | 0.0 | 0.0 | 0.0 | 7.0 | 2.0 | 0.0 |
| | TiO₂ | 6.0 | 6.0 | 6.0 | 6.0 | 6.0 | 7.0 | 4.0 | 6.0 |
| | Nb₂O₅ | 0.0 | 0.0 | 0.0 | 0.0 | 0.0 | 0.0 | 1.0 | 0.0 |
| | Ta₂O₅ | 0.0 | 0.0 | 0.0 | 0.0 | 0.0 | 0.0 | 0.0 | 0.0 |
| | La₂O₃ | 0.0 | 0.0 | 0.0 | 0.0 | 0.0 | 0.0 | 0.0 | 0.0 |
| | SrO | 0.0 | 0.0 | 0.0 | 0.0 | 0.0 | 0.0 | 0.0 | 1.0 |
| | BaO | 0.0 | 0.0 | 0.0 | 0.0 | 0.0 | 0.0 | 0.0 | 1.0 |
| | Bi₂O₃ | 7.0 | 9.0 | 9.0 | 10.0 | 12.0 | 4.0 | 8.0 | 9.0 |
| | SiO₂ + B₂O₃ | 53.5 | 50.5 | 53.5 | 52.5 | 50.5 | 53.0 | 55.0 | 50.0 |
| | MgO + ZnO + TiO₂ | 15.0 | 16.0 | 12.0 | 12.0 | 12.0 | 21.0 | 11.0 | 14.0 |
| | Nb₂O₅ + Ta₂O₅ | 0.0 | 0.0 | 0.0 | 0.0 | 0.0 | 0.0 | 1.0 | 0.0 |
| Glass | Glass | 431 | 424 | 423 | 412 | 427 | (col- | (col- | 426 |
| prop- | transition | | | | | | ored) | ored) | |
| erty | point [° C.] | | | | | | | | |
| | Refractive | 1.710 | 1.707 | 1.731 | 1.747 | 1.775 | — | — | 1.747 |
| | index | | | | | | | | |
| Lens | Angular | 16.5 | 17.4 | 16.3 | 16.7 | 17.1 | 16.0 | 16.0 | 17.6 |
| prop- | aperture 8 | | | | | | | | |
| erty | [°] | | | | | | | | |
| | Δfₘₐₓ[μm] | 50 | 70 | 30 | 30 | 110 | 100 | 100 | 90 |

The base glass compositions having the makeups of Examples 1 to 19 each were spun to produce a rod-form glass having a diameter of 0.45 mm. This rod-form glass was immersed for a given time period in molten sodium nitrate at the glass transition point of the glass to conduct an ion-exchange treatment.

As a result, Li⁺ ions contained in the rod-form glass were replaced with Na⁺ ions contained in the molten salt to form a refractive-index distribution based on the distribution of Li⁺ ion concentration. Thus, graded-refractive-index rod lenses were produced.

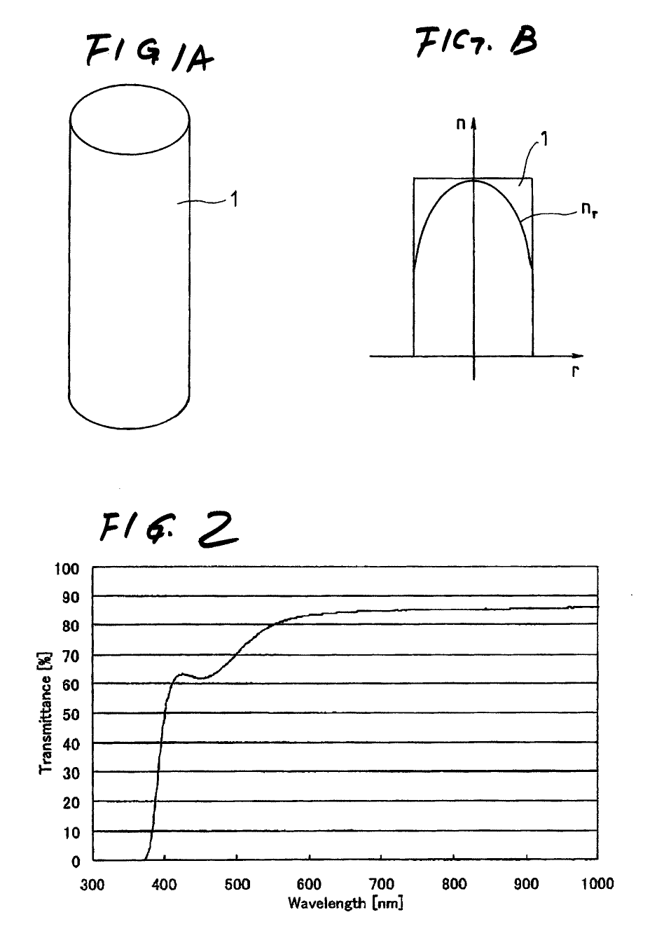

In FIG. 1A is shown a diagrammatic view of a graded-refractive-index rod lens 1. FIG. 1B is a view diagrammatically illustrating a refractive-index distribution curve nᵣ formed in the graded-refractive-index rod lens 1.

Methods for evaluating properties of these lenses are shown below.

First, angular aperture was determined. The graded-refractive-index rod lens of each Example was cut into 10 mm, and both end faces were mirror-polished so as to become parallel. A lattice pattern was brought into contact with one of the end faces, and the length of that central part of the opposite end face in which an erecting one-magnification image of the lattice pattern was obtained most clearly was determined. This length is taken as one-pitch length. Furthermore, the refractive index of the base glass composition was taken as the refractive index of the center of the graded-refractive-index rod lens, and this refractive index of the center and the one-pitch length were substituted into the following equation (1) to thereby determine the angular aperture.

### (Su-1)

θ=180×n₀×0.45/P (1)

In equation (1), θ is angular aperture (°); P is one-pitch length (mm); and n₀ is the refractive index of the center of the graded-refractive-index rod lens.

Resolution was evaluated next. The one-pitch length obtained in the determination of angular aperture is used as a reference. A point where an image was obtained most clearly was determined while radially shifting the examination position from the center toward the periphery, and the divergence of that point from the one-pitch length in the optical-axis direction was measured. The biggest of the divergence values thus measured in various positions in radial directions was defined as the maximum curvature of image field Δfₘₐₓ, which was used for evaluating the resolution of the graded-refractive-index rod lens. The smaller the value of Δfₘₐₓ, the better the resolution.

### (Results of Lens Property Evaluation)

Examples 1 to 6 are makeups having a Bi₂O₃ content of 4-6% by mole. These glasses had a relatively high B₂O₃ content in the range of 10-30% by mole, and glass coloration could be sufficiently inhibited and the lens properties could be satisfactorily evaluated. The results obtained are also shown in Table 1.

Examples 7 to 19 are makeups having a Bi₂O₃ content of 7-12% by mole. These glasses had low viscosity and a reduced melting temperature. Glass coloration could hence be sufficiently inhibited, and the lens properties could be satisfactorily evaluated. The results obtained are also shown in Tables 2 and 3.

It is preferred to suitably select a glass composition makeup within the range specified in the invention while taking account of lens properties required, i.e., whether the lens to be produced is one having a large angular aperture θ or one having a small value of maximum curvature of image field Δfₘₐₓ.

FIG. 2 shows a transmission spectrum of a glass having the makeup of Example 17. As shown in FIG. 2, the glass having the makeup of Example 17, which contains 9% by mole Bi₂O₃, shows absorption in the wavelength range of from 400 nm to 500 nm. However, this absorption has a low intensity, and the bottom of the absorption peak reaches about 600 nm at the most. Because of this, the glass having this makeup is satisfactorily usable as a graded-refractive-index rod lens when used with a light having a suitably selected wavelength, such as a light in a range of wavelengths longer than those, e.g., 700 nm.

### EXAMPLES 20 AND 21

Raw materials were mixed according to each of the makeups of Examples 20 and 21 shown in Table 3, and the mixture was melted to produce a base glass composition. Example 20 is a glass makeup having a B₂O₃ content of 5% by mole. Example 21 is a glass makeup having a Bi₂O₃ content of 8% by mole, These glass compositions have assumed a color. However, the coloration is in such a low degree that the lenses are usable with a light having a limited wavelength.

Graded-refractive-index rod lenses were produced from rod-form glasses having the makeups of Examples 20 and 21 by ion exchange in the same manner as in Examples 1 to 19. The properties of these lenses could be evaluated. The results obtained are also shown in Table 3.

The graded-refractive-index rod lenses produced from the compositions of Examples 20 and 21 had an angular aperture θ of 16.0°.

### EXAMPLE 22

Raw materials were mixed according to the makeup of Example 22 shown in Table 3, and the mixture was melted to produce a base glass composition.

Example 22 is a glass makeup containing 1% by mole SrO and 1% by mole BaO.

Like the glass compositions of Examples 7 to 19, the glass composition of Example 22 has a higher Bi₂O₃ content than in Examples 1 to 6. However, glass coloration could be sufficiently inhibited, and the lens properties could be satisfactorily evaluated. The results obtained are also shown in Table 3. Because this glass contains SrO and BaO, it is thought that these components contribute to a-decrease in melting temperature and an increase in refractive index.

### COMPARATIVE EXAMPLES 1 TO 5

The makeups of the Comparative Examples are shown in Table 4. In Comparative Examples 1 to 5, at least one of the component content ranges in the glass composition for graded-refractive-index rod lenses of the invention is not satisfied. Raw-material mixing, melting, spinning, and lens evaluation were conducted by the same methods as in the Examples.

TABLE 4

| | | Comparative Example No. | | | | |
|---|---|---|---|---|---|---|
| | | 1 | 2 | 3 | 4 | 5 |
| Compo- | SiO₂ | 53.0 | 48.0 | 39.0 | 30.0 | 20.0 |
| nent | B₂O₃ | 0.0 | 2.0 | 14.0 | 35.0 | 35.0 |
| [mol %] | Li₂O | 15.0 | 16.0 | 15.0 | 14.0 | 13.0 |
| | Na₂O | 7.0 | 10.0 | 12.0 | 10.0 | 11.0 |
| | MgO | 11.0 | 10.0 | 9.0 | 3.0 | 4.0 |
| | ZnO | 3.0 | 0.0 | 0.0 | 3.0 | 2.0 |
| | TiO₂ | 3.0 | 10.0 | 1.0 | 3.0 | 5.0 |
| | Nb₂O₅ | 0.0 | 0.0 | 4.0 | 0.0 | 0.0 |
| | Ta₂O₅ | 0.0 | 4.0 | 3.0 | 0.0 | 2.0 |
| | La₂O₃ | 3.0 | 0.0 | 0.0 | 0.0 | 0.0 |
| | SrO | 0.0 | 0.0 | 0.0 | 0.0 | 0.0 |
| | BaO | 2.0 | 0.0 | 0.0 | 0.0 | 0.0 |
| | Bi₂O₃ | 3.0 | 0.0 | 3.0 | 2.0 | 8.0 |
| | SiO₂ + B₂O₃ | 53.0 | 50.0 | 53.0 | 65.0 | 55.0 |
| | MgO + ZnO + TiO₂ | 17.0 | 20.0 | 10.0 | 9.0 | 11.0 |
| | Nb₂O₅ + Ta₂O₅ | 0.0 | 4.0 | 7.0 | 0.0 | 2.0 |
| Glass | Glass | (col- | 527 | (opaque) | 469 | (opaque) |
| prop- | transition | ored) | | | | |
| erty | point [° C.] | | | | | |
| | Refractive | — | 1.681 | — | 1.599 | — |
| | index | | | | | |
| Lens | Angular | 14.5 | 15.8 | — | (opaci- | — |
| prop- | aperture | | | | fied) | |
| erty | θ [°] | | | | | |
| | Δfₘₐₓ[μm] | 200 | 50 | — | — | — |

Comparative Example 1 is a glass makeup containing no B₂O₃ and having a Bi₂O₃ content of 3% by mole. This makeup includes La₂O₃, which is a component not contained in Examples 1 to 22.

This glass composition had a color and was found to be difficult to use as a glass composition for graded-refractive-index rod lenses.

Comparative Example 2 is a glass makeup having a B₂O₃ content of 2% by mole and containing no Bi₂O₃. The graded-refractive-index rod lens produced from this glass composition had an angular aperture θ of 15.8°, which was smaller than 16°.

Comparative Example 3 is a glass makeup in which the total content of Nb₂O₅ and Ta₂O₅ is 7% by mole. This makeup failed to give a transparent glass composition.

Comparative Example 4 is a glass makeup having a B₂O₃ content of 35% by mole. The surface of the rod-form glass produced from this glass composition opacified during the ion-exchange treatment. This glass was hence found to be difficult to use as a graded-refractive-index rod lens.

Comparative Example 5 is a glass makeup having a Bi₂O₃ content of 8% by mole and a B₂O₃ content of 35% by mole. This makeup failed to give a transparent glass composition.

### INDUSTRIAL APPLICABILITY

According to the invention, a base glass composition which contains neither lead nor thallium and is suitable for producing a graded-refractive-index rod lens having an angular aperture of 16-20° can be provided. Furthermore, a graded-refractive-index rod lens produced from the composition can be provided.

1. A base glass composition for graded-refractive-index rod lenses, comprising, in terms of % by mole,
20≦SiO₂≦52,
1≦B₂O₃≦30,
12≦Li₂O≦18,
8≦Na₂O≦15,
0≦MgO≦15,
0≦SrO≦10,
0≦BaO≦10,
0≦ZnO≦15,
0<TiO₂≦15,
0≦Nb₂O₅≦5,
0≦Ta₂O₅≦5, and
3<Bi₂O₃≦13,
provided that
45≦SiO₂+B₂O₃≦65,
9≦MgO+ZnO+TiO₂≦25, and
0≦Nb₂O₅+Ta₂O₅≦5,
and by containing substantially no lead and substantially no thallium.

2. The base glass composition for graded-refractive-index rod lenses according to claim 1, wherein
the content of B₂O₃ is in the range of
6≦B₂O₃≦30
in terms of % by mole.

3. The base glass composition for graded-refractive-index rod lenses according to claim 1, wherein
the total content of SiO₂ and B₂O₃ is in the range of
50≦SiO₂+B₂O₃≦60
in terms of % by mole.

4. The base glass composition for graded-refractive-index rod lenses according to claim 1, wherein
the contents of MgO, ZnO, and TiO₂ are respectively in the ranges of
2≦MgO≦10,
0≦ZnO≦10, and
2≦TiO₂≦10
in terms of % by mole.

5. The base glass composition for graded-refractive-index rod lenses according to claim 1, wherein
the total content of Nb₂O₅ and Ta₂O₅ is in the range of
0≦Nb₂O₅+Ta₂O₅≦3
in terms of % by mole.

6. A graded-refractive-index rod lens characterized by being obtained by forming the base glass composition for graded-refractive-index rod lenses according to claim 1 into a cylindrical rod and treating the rod by the ion-exchange method to form a refractive-index distribution therein.

7. The graded-refractive-index rod lens according to claim 6, wherein the graded-refractive-index rod lens has an angular aperture of 16-20°.
